(19) United States
(12) Patent Application Publication
(10) Pub. No.: US 2008/0055326 A1
(43) Pub. Date: Mar. 6, 2008

(54) Processing of Command Sub-Lists by Multiple Graphics Processing Units

(76) Inventors: Yun Du, San Diego, CA (US); Chun Yu, San Diego, CA (US); Guofang Jiao, San Diego, CA (US); Lingjun Chen, San Diego, CA (US)

Correspondence Address: QUALCOMM INCORPORATED, 5775 MOREHOUSE DR., SAN DIEGO, CA, 92121, US

(21) Appl. No.: 11/469,932

(22) Filed: Sep. 5, 2006

(51) Int. Cl. G09G 5/36

(52) U.S. Cl. 345/553

(57) ABSTRACT

Techniques to allow multiple graphics processing units to operate in parallel, even with limited storage space, are described. An apparatus includes first and second processing units and a memory. The first processing unit performs pre-processing on a batch of graphics application data for an image (e.g., for vertices in the image) and generates command sub-lists for the batch. The second processing unit performs post-processing on the command sub-lists (e.g., for pixels of the image) and generates output data for the image. The first and second processing units may operate in parallel on different command sub-lists. The memory stores the command sub-lists and may also store a header for each command sub-list, a look-up table of memory addresses for the command sub-lists, a write counter indicating the most recently generated command sub-list, and a read counter indicating the most recently post-processed command sub-list.

### BACKGROUND

I. Field

The present disclosure relates generally to electronics, and more specifically to techniques for operating graphics processing units.

II. Background

Graphics processing units are widely used to render 2-dimensional (2-D) and 3-dimensional (3-D) images for various applications such as video games, graphics, computer-aided design (CAD), simulation and visualization tools, imaging, etc. A 3-D image may be modeled with surfaces, and each surface may be approximated with polygons (typically triangles). The number of triangles used to represent a 3-D image is dependent on the complexity of the surfaces as well as the desired resolution of the image and may be quite large, e.g., in the millions. Each triangle is defined by three vertices, and each vertex is associated with various attributes such as space coordinates, color values, and texture coordinates. Each attribute may have up to four components.

Multiple graphics processing units may be used to perform various graphics operations to render an image. Each graphics processing unit may perform certain graphics operations and may pass its output to the next graphics processing unit. For example, a pre-processing unit may perform processing on graphics application data for vertices of primitives (e.g., points, lines, and/or triangles) in the image and provide a data package. A post-processing unit may then operate on the data package and perform processing for pixels to generate output data for the image.

To improve efficiency, the pre-processing and post-processing units may operate on batches. Each batch may be for certain graphics operations on all or portion of the image. For example, one batch may draw the background of the image, another batch may draw pictures in the image, etc. For each batch, the pre-processing unit may operate on graphics application data for that batch and generate a data package, which may be stored in a memory. The post-processing unit may then operate on the data package and generate output data for the batch. Each batch is associated with overhead for commands and global variables that are applicable for the entire batch. Processing a large batch is generally more efficient since the overhead is reduced. However, a large batch also results in a larger data package from the pre-processing unit.

The available memory may be limited. In this case, the pre-processing and post-processing units may operate on one batch at a time in a sequential manner. The pre-processing unit may complete processing for a batch and store a data package in the memory. The post-processing unit may then operate on the data package. When the post-processing unit completes processing on the data package, the pre-processing unit may perform processing for the next batch. This sequential operation of the pre-processing and pre-processing units due to limited memory is inefficient.

### SUMMARY

Techniques to allow multiple graphics processing units (e.g., a pre-processing unit and a post-processing unit) to operate in parallel, even with limited storage space, are described herein. The techniques may improve the performance of these graphics processing units.

In an embodiment, an apparatus includes first and second processing units and a memory. The first processing unit performs pre-processing on a batch of graphics application data for an image and generates a plurality of command sub-lists for the batch. Each command sub-list includes a portion of intermediate data (a command list or data package) generated for the batch. The second processing unit performs post-processing on the plurality of command sub-lists and generates output data for the image. The first processing unit may perform pre-processing for vertices in the image, and the second processing unit may perform post-processing for pixels of the image. The first and second processing units may operate in parallel. The first processing unit may perform pre-processing for one command sub-list, and the second processing unit may concurrently perform post-processing for another command sub-list.

The memory stores the plurality of command sub-lists, e.g., as a circular buffer. The memory may also store a header for each command sub-list, a look-up table of memory addresses for the plurality of command sub-lists, a write counter indicating the most recently generated command sub-list, a read counter indicating the most recently post-processed command sub-list, and/or other information for the command sub-lists.

Various aspects and embodiments of the disclosure are described in further detail below.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 shows a block diagram of a graphics system.

FIG. 2 shows partitioning of a command list into command sub-lists.

FIG. 3 shows a block diagram of a graphics system with command sub-lists.

FIG. 4 shows a process for performing graphics processing.

FIG. 5 shows a block diagram of a wireless device.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

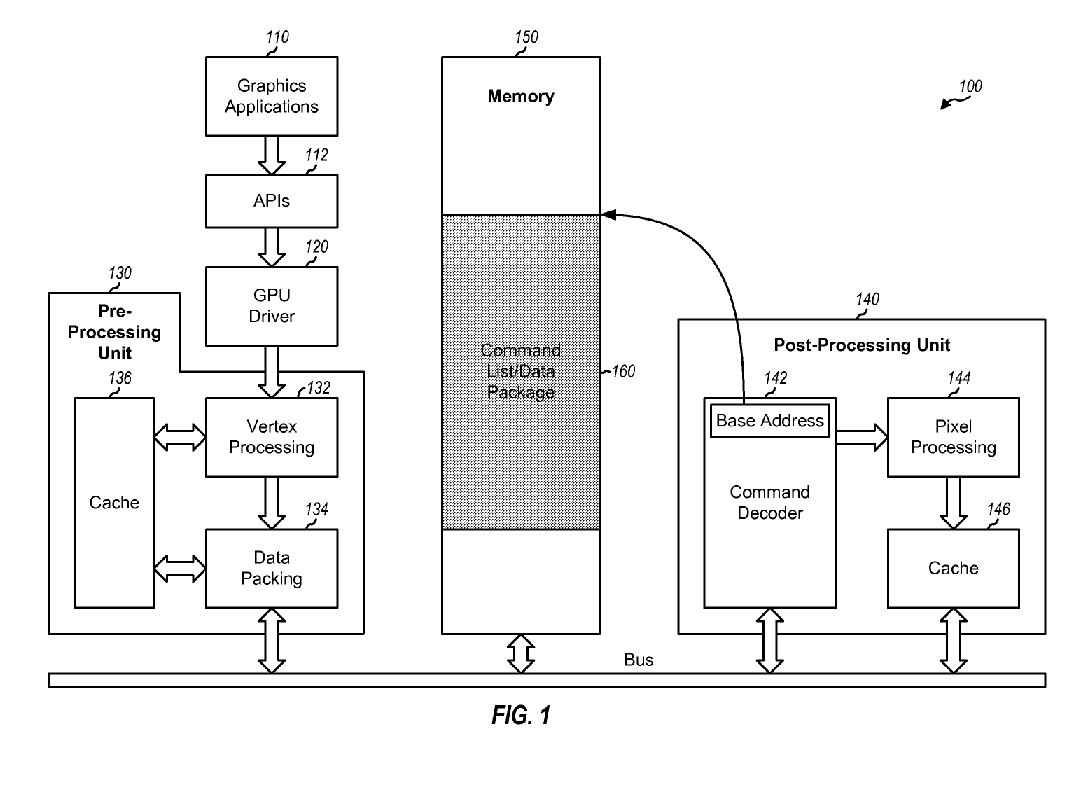

FIG. 1 shows a block diagram of a graphics system 100, which may be a stand-alone system or part of a larger system such as a computing system, a wireless communication device, etc. Graphics applications 110 (which may be for video games, graphics, videoconference, etc.) generate high-level commands to perform graphics operations on graphics application data. The high-level commands may be relatively complex but the graphics application data may be fairly compact. The graphics application data may include geometry information (e.g., information for vertices of primitives in an image), information describing what the image looks like, etc. Application programming interfaces (APIs) 112 provide an interface between graphics applications 110 and a graphics processing unit (GPU) driver 120, which may be software and/or firmware executing on a processor. GPU driver 120 converts the high-level commands to low-level commands, which may be machine dependent and tailored for the underlying processing units. GPU driver 120 also indicates where data is located, e.g., which buffers store the data.

A pre-processing unit 130 performs vertex-based processing and, in the embodiment shown in FIG. 1, includes a vertex processing unit 132, a data packing unit 134, and a cache 136. Vertex processing unit 132 performs vertex operations on the graphics application data, as instructed by the low-level commands, and generates intermediate data. The vertex operations may include vertex transformation, lighting, geometry blending, displacement, etc. The intermediate data may include vertex data, primitive data, and pre-processed commands. The vertex data conveys various attributes of the vertices. The primitive data may indicate how vertices are connected to form primitives. The pre-processed commands indicate how to process the vertices in the next stage and are generated by pre-processing unit 130 based on the low-level commands. The pre-processed commands may comprise rendering states, etc. Data packing unit 134 packs the intermediate data into a data package, which is also referred to as a command list 160. GPU driver 120 may coordinate the data packing as described below. The command list is stored in a memory 150. A cache 136 provides fast, local storage for pre-processing unit 130.

A post-processing unit 140 performs pixel-based processing and, in the embodiment shown in FIG. 1, includes a command decoder 142, a pixel processing unit 144, and a cache 146. Command decoder 142 fetches the command list from memory 150, decodes the pre-processed commands, and dispatches the decoded commands and associated data to pixel processing unit 144. The pre-processed commands may include information on how the command list is constructed and/or where the associated data is stored. Command decoder 142 may maintain a base address register that points to the current pre-processed command being operated on by post-processing unit 140. Pixel processing unit 144 performs pixel processing as instructed by the decoded commands and provides output data. The pixel processing may include rasterization, pixel interpolation, texture mapping, fragment shading, hidden surface removal, alpha blending and logic operations on color buffer, etc. The output data may be final results for the image (e.g., color information), data for the next stage or iteration for the image, etc. A cache 146 provides fast, local storage for post-processing unit 140.

Processing units 130 and 140 may also be referred to as cores, engines, machines, processors, etc. Pre-processing unit 130 and post-processing unit 140 may each be implemented with a processor, a reduced instruction set computer (RISC), an Advanced RISC Machine (ARM), a digital signal processor (DSP), etc. Post-processing unit 140 may also be referred to as a graphics rendering processor (GRP).

Pre-processing unit 130 operates on graphics application data and generates intermediate data, which may include vertex data and primitive data. The vertex data may convey various attributes of the vertices in the image being operated on. These attributes may include space coordinates, color values, and texture coordinates. Space coordinates may be given by either three components x, y and z or four components x, y, z and w, where x and y are horizontal and vertical coordinates, z is depth, and w is a homogeneous coordinate. Color values may be given by three components r, g and b or four components r, g, b and a, where r is red, g is green, b is blue, and a is a transparency factor that determines the transparency of a pixel. Texture coordinates are typically given by horizontal and vertical coordinates, u and v.

The graphics application data operated on by pre-processing unit 130 may be fairly compact. The intermediate data generated by pre-processing unit 130 may be fairly large, especially for a large batch for many vertices. As the number of vertices increases, the size of the intermediate data increases correspondingly, and the command list grows similarly.

The command list generated by pre-processing unit 130 may be quite large and may require a large amount of memory for storage. Memory 150 may have a limited size, especially if graphics system 100 is part of a mobile device such as a cellular phone. The limited storage space in memory 150 may cause GPU driver 120 to wait until post-processing unit 140 completes processing of the command list stored in memory 150 before starting the next batch. Pre-processing unit 130 and post-processing unit 140 may then operate serially, with one processing unit using memory 150 at any given moment. In a more severe scenario, insufficient space may be available in memory 150 to store the command list, which may then cause graphics applications 110 to crash.

Techniques to allow multiple graphics processing units (e.g., a pre-processing unit and a post-processing unit) to operate in parallel, even with limited storage space, are described herein. The techniques may improve the performance of these graphics processing units.

In an embodiment, a command list for a batch is partitioned into smaller command sub-lists. Each command sub-list may include a different section of the command list/data package. In general, the command list may be partitioned into any number of command sub-lists, and these command sub-lists may be of any sizes. Performance may improve if the command sub-lists are roughly of a certain size and include complete primitives. Having command sub-lists of similar sizes may improve memory utilization. Having each primitive included in one command sub-list may improve processing efficiency since each primitive may be associated with certain overhead. This overhead may be incurred only once if the primitive is included in one command sub-list. The command list may be partitioned dynamically on-the-fly as the batch is being processed. The partitioning may be based on the available memory, the amount of intermediate data generated by the pre-processing unit, the rate at which the post-processing unit operates on the command sub-lists, etc.

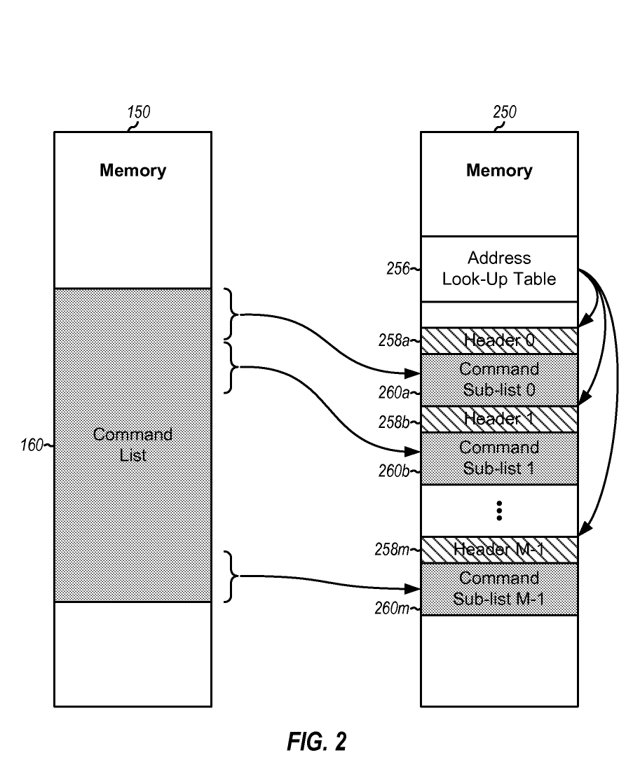

FIG. 2 shows an embodiment of the partitioning of a command list into command sub-lists. Memory 150 stores command list 160, as described above for FIG. 1. A memory 250 may store the same command list in a different manner for efficient memory utilization and processing.

Command list 160 may be partitioned into M command sub-lists 260a through 260m, which are labeled as command sub-lists 0 through M−1, respectively, in FIG. 2. In general, M may be any value for a given batch and may vary from batch to batch. Command sub-list 0 may include the first section of command list 160, command sub-list 1 may include the next section of command list 160, etc., and command sub-list M−1 may include the last section of command list 160.

In an embodiment, each command sub-list 260 is associated with a header 258 that conveys the following information:
Whether the command sub-list is the first command sub-list for a new command list/batch or is a continuation of the previous command sub-list, and
The size of the command sub-list.

### Header 258 may also convey whether the command sub-list is the last command sub-list for the current command list and/or other information.

An address look-up table 256 identifies the command sub-lists stored in memory 250. In an embodiment, address look-up table 256 stores the memory address of the header for each command sub-list that is generated and stored in memory 250. Address look-up table 256 may be updated as new command sub-lists are generated.

In an embodiment, the generated command sub-lists are assigned sequentially numbered wrapped-around indices, which go from 0 through N−1, then wrap around to 0 and continue. N may be equal to or larger than the maximum number of command sub-lists to store in memory 250 at any given moment. Each new command sub-list is assigned the next index from the index of the previous command sub-list. The first command sub-list for a new command list/batch is assigned the next index from the index of the last command sub-list for the prior command list/batch. In the example shown in FIG. 2, the first command sub-list for the next command list would be referred to as command sub-list M+1. This sequential indexing of the command sub-lists may simplify record keeping for the command sub-lists, as described below.

In general, the partitioning of the command list into command sub-lists may be controlled by the GPU driver, by the pre-processing unit, by some other unit, or by a combination of units. In an embodiment that is described below, the GPU driver breaks the command list into command sub-lists and may do so at any positions in the command list.

Post-processing unit 140 uses the header to determine whether the current command sub-list is for the current batch or a new batch. If the current command sub-list is for a new batch, then post-processing unit 140 may perform any setup required for the new batch (e.g., setting up global variables that are applicable for the entire batch) prior to processing the command sub-list. Otherwise, if the current command sub-list is a continuation of the previous command sub-list, then post-processing unit 140 may process the current command sub-list using the settings for the current batch. Post-processing unit 140 uses the command sub-list size to ascertain the end of the current command sub-list.

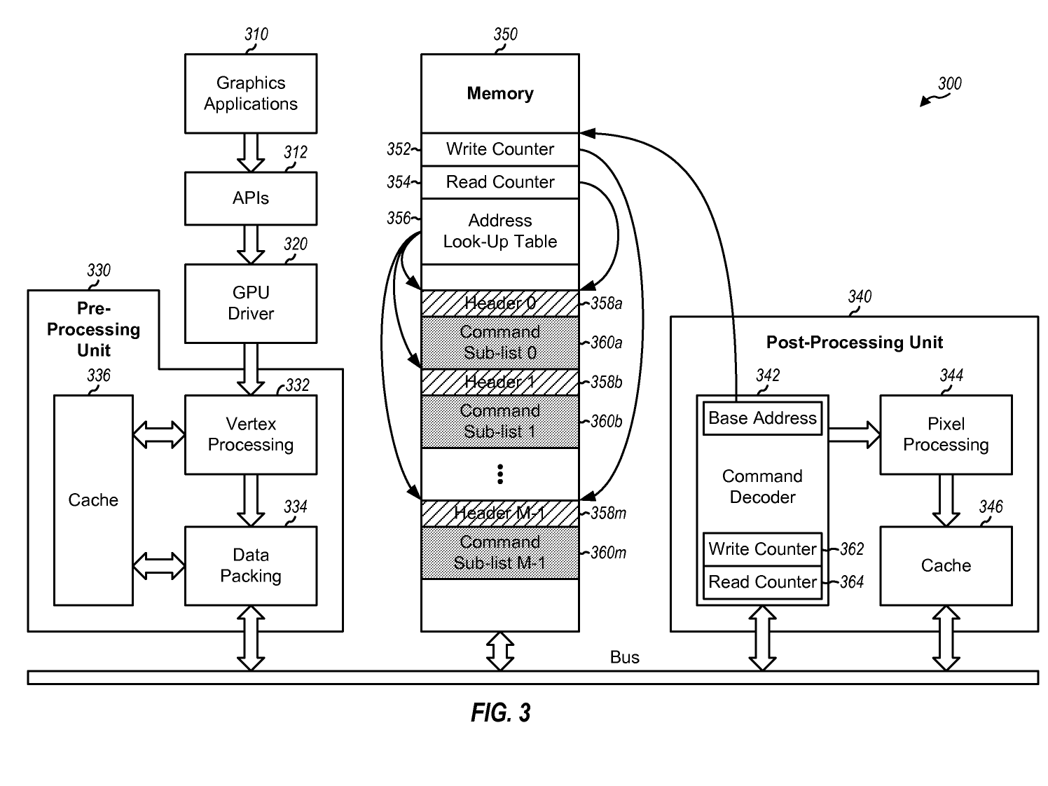

FIG. 3 shows a block diagram of an embodiment of a graphics system 300 with a command list partitioned into command sub-lists. Graphics system 300 includes graphics applications 310, APIs 312, a GPU driver 320, a pre-processing unit 330, a post-processing unit 340, and a memory 350, which operate in similar manners as units 110, 112, 120, 130, 140, and 150, respectively, in FIG. 1.

Memory 350 stores command sub-lists 360a through 360m, the associated headers 358a and 358m, respectively, and an address look-up table 356, as described above for FIG. 2. In an embodiment, a write counter 352 and a read counter 354 are also maintained for the command sub-lists. The counters may also be referred to as pointers, etc. Write counter 352 points to the command sub-list generated most recently and stored in memory 350. Read counter 354 points to the command sub-list most recently post-processed by post-processing unit 140. Write counter 352 and read counter 354 thus convey the current state of the command sub-lists.

In an embodiment, post-processing unit 140 stores a write counter 362 and a read counter 364. In an embodiment, write counter 362 is a copy of write counter 352, and read counter 354 is a copy of read counter 364. Write counter 362 and read counter 364 mirror write counter 352 and read counter 354, respectively, and are used to reduce communication overhead between pre-processing unit 330 and post-processing unit 340.

GPU driver 320 or pre-processing unit 130 may update write counters 352 and 362 at the same time whenever a new command sub-list is generated. Post-processing unit 140 may update read counters 354 and 364 at the same time whenever a command sub-list is post-processed, e.g., upon fetching the command sub-list from memory 350. The fetched command sub-list may be decoded by a command decoder 342 and executed by a pipeline within a pixel processing unit 344. The fetched command sub-list does not need to be retained in memory 350.

In an embodiment, GPU driver 320 coordinates the generation of the command sub-lists. GPU driver 120 may break a batch from graphics applications 310 into smaller batches, dispatch or invoke pre-processing unit 330 like a function call, and instruct pre-processing unit 330 to operate on each smaller batch for a set of vertices. Pre-processing unit 330 may generate intermediate data for each smaller batch and write the intermediate data to specific location of memory 350 as indicated by GPU driver 320. GPU driver 320 may monitor the amount of intermediate data generated by pre-processing unit 330. When a certain amount of intermediate data has been accumulated in memory 350, GPU driver 320 may flush the current command sub-list. For example, GPU driver 320 may generate a header for the command sub-list, update (e.g., increments by one) write counters 352 and 362, and update address look-up table 356. If sufficient memory resources are still available, then GPU driver 320 may continue to send smaller batches to pre-processing unit 330, and the accumulation of intermediate data for the next command sub-list may then commence. GPU driver 320 may thus control the generation of the command sub-lists based on the intermediate data generated by pre-processing unit 330 and the availability of memory resources.

Post-processing unit 340 can ascertain whether one or more command sub-lists are ready for post-processing based on read counter 362 and write counter 364. In the embodiment described above, the command sub-lists are assigned sequential indices that wrap around, and counters 352, 354, 362 and 364 may be implemented as wrap-around counters that count from 0 to a maximum value of N−1 and then resets to zero. Read counters 352 and 362 are updated whenever a new command sub-list is generated, and write counters 354 and 364 are updated whenever a command sub-list is fetched from memory 350. Post-processing unit 340 may detect for a mismatch between counters 362 and 364, which indicates that at least one command sub-list is ready for execution. If a counter mismatch is detected, then post-processing unit 340 may fetch from memory 350 the next command sub-list indicated by read counter 364. After fetching the command sub-list, post-processing unit 340 may update both read counters 354 and 364.

The read and write counters provide an efficient mechanism for communicating between pre-processing unit 330 and post-processing unit 340 regarding the progress of batch processing. A single set of read and write counters may be used to support any number of command sub-lists for any number of batches of any sizes. Each new batch is identified by the header of the first command sub-list for that batch. A single address look-up table may also be used for all command sub-lists generated for all batches.

GPU driver 320 may also coordinate the allocation and release of resources for the command sub-lists. After each update of read counters 352 and 362, GPU driver 320 may release the associated resources, which may include memory 350, a vertex buffer, an index buffer, a frame buffer, etc. The released resources may be reused for new command sub-lists. This may reduce resource requirements in several ways. First, memory 350 is efficiently utilized to store only command sub-lists that have been generated but not yet executed by post-processing unit 340. Memory resources for each command sub-list may be released as soon as the command sub-list is fetched by post-processing unit 340, and the released memory resources may be used for another command sub-list. Second, resource requirements for execution of the command sub-lists may potentially be reduced because not all resources may be required for a given command sub-list. For example, some command sub-lists may not need a texture buffer all the time, so the resources for the texture buffer may be allocated later and/or released earlier.

In the embodiment described above, memory 350 is used as a circular buffer to store the command sub-lists generated by pre-processing unit 330. This embodiment allows for efficient utilization of the available memory space and supports command sub-lists of varying sizes. The space available in memory 350 at any given moment may be determined based on the read and write counters and the command sub-list size in the header. Other memory structures may also be used to store the command sub-lists.

In another embodiment, pre-processing unit 330 includes a command decoder capable of decoding commands and data from GPU driver 320. GPU driver 320 may generate command arrays for pre-processing unit 330 and may store the command arrays in a memory, e.g., memory 350 or another memory. Pre-processing unit 330 may operate on the command arrays and generate command sub-lists for post-processing unit 340. The command arrays may be similar in concept to the command sub-lists. There may be a one-to-one mapping between the command arrays and the command sub-lists. Alternatively, each command array may be mapped to one or more command sub-lists. The communication between GPU driver 320 and pre-processing unit 330 may be similar to the communication between pre-processing unit 330 and post-processing unit 340, e.g., via the command arrays and read and write counters for these command arrays. This embodiment allows GPU driver 320, pre-processing unit 330, and post processing unit 340 to operate in parallel. For example, GPU driver 320 may operate on a CPU (e.g., an ARM), pre-processing unit 330 may operate on a DSP, and post-processing unit 340 may operate on a dedicated graphics processor.

FIGS. 1 through 3 show a configuration with a GPU driver, a pre-processing unit, and a post-processing unit. The techniques described herein for partitioning a batch into multiple command arrays and/or multiple command sub-lists may also be used for other configurations such as, e.g., (a) driver→GPU, (b) driver→DSP→GPU, and (c) driver→DSP→driver→GPU. The techniques may be used for passing commands and/or data between any two units (or for each “→”) in each of these alternative configurations.

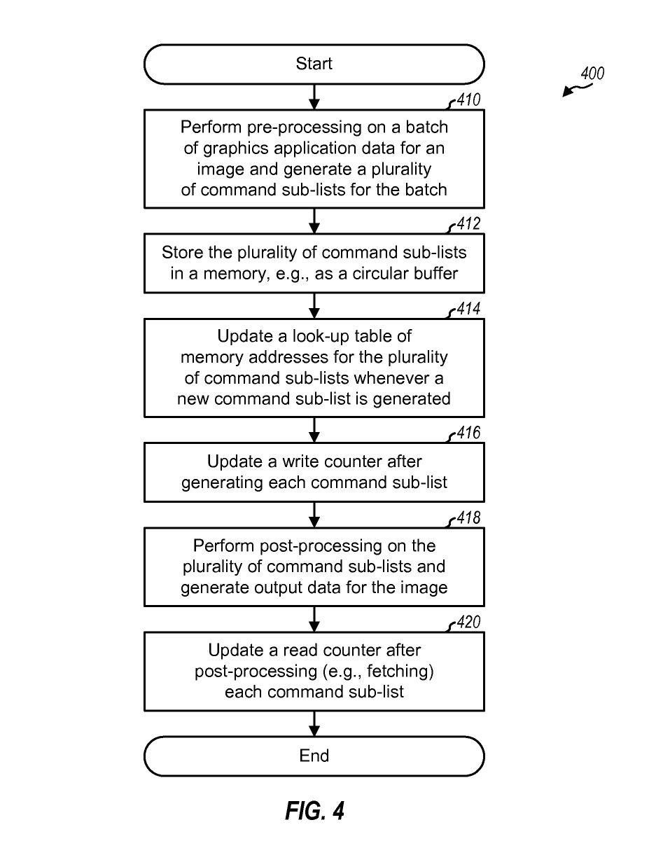

FIG. 4 shows an embodiment of a process 400 for performing graphics processing in accordance with the techniques described herein. Pre-processing is performed on a batch of graphics application data for an image (e.g., for vertices in the image) to generate a plurality of command sub-lists for the batch (block 410). Each command sub-list includes a portion of intermediate data (a command list or data package) generated for the batch. Each command sub-list may include vertex data, primitive data, and pre-processed commands, e.g., for complete primitives of the image.

The plurality of command sub-lists may be stored in a memory, e.g., as a circular buffer (block 412). A look-up table of memory addresses for the plurality of command sub-lists may be maintained and updated whenever a new command sub-list is generated (block 414). A header may be provided for each command sub-list and may indicate (a) whether the command sub-list is the first command sub-list for the batch and (b) the size of the command sub-list. A write counter may be maintained to indicate the most recently generated command sub-list and may be updated after generating each command sub-list (block 416).

Post-processing is performed on the plurality of command sub-lists (e.g., for pixels of the image) to generate output data for the image (block 420). The pre-processing and post-processing may be performed in parallel. For example, pre-processing may be performed for one command sub-list, and post-processing may be performed concurrently for another command sub-list. A read counter may be maintained to indicate the most recently post-processed command sub-list and may be updated after post-processing (e.g., fetching) each command sub-list (block 422). A copy of the read and write counters may be used for communication between the pre-processing and post-processing.

The techniques described herein support parallel operation of the pre-processing and post-processing units and further efficiently utilize the available memory resources, which may be limited. The techniques may be used for wireless communication, computing, networking, personal electronics, etc. An exemplary application of the techniques for wireless communication is described below.

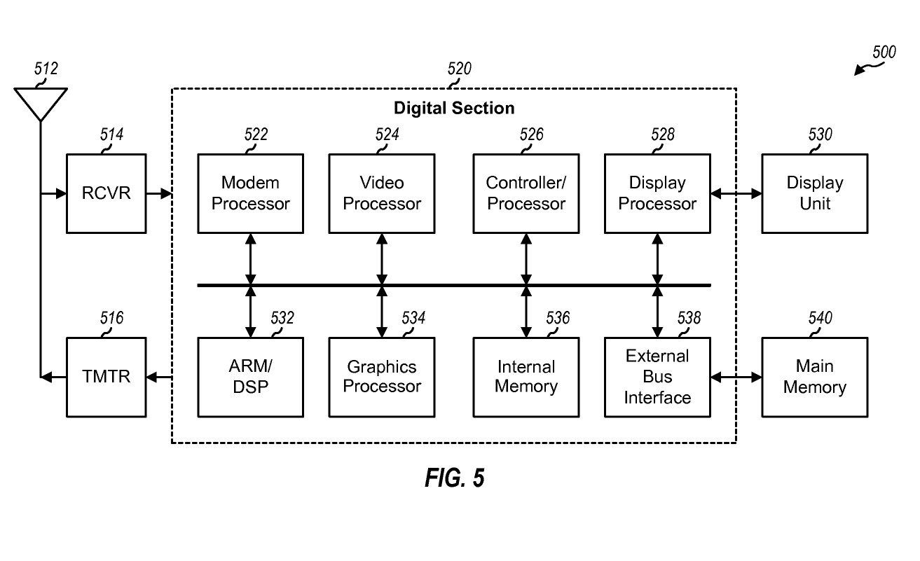

FIG. 5 shows a block diagram of an embodiment of a wireless device 500 in a wireless communication system. Wireless device 500 may be a cellular phone, a terminal, a handset, a personal digital assistant (PDA), or some other device. The wireless communication system may be a Code Division Multiple Access (CDMA) system, a Global System for Mobile Communications (GSM) system, or some other system.

Wireless device 500 is capable of providing bi-directional communication via a receive path and a transmit path. On the receive path, signals transmitted by base stations are received by an antenna 512 and provided to a receiver (RCVR) 514. Receiver 514 conditions and digitizes the received signal and provides samples to a digital section 520 for further processing. On the transmit path, a transmitter (TMTR) 516 receives data to be transmitted from digital section 520, processes and conditions the data, and generates a modulated signal, which is transmitted via antenna 512 to the base stations.

Digital section 520 includes various processing, interface and memory units such as, for example, a modem processor 522, a video processor 524, a controller/processor 526, a display processor 528, an ARM/DSP 532, a graphics processor 534, an internal memory 536, and an external bus interface (EBI) 538. Modem processor 522 performs processing for data transmission and reception (e.g., encoding, modulation, demodulation, and decoding). Video processor 524 performs processing on video content (e.g., still images, moving videos, and moving texts) for video applications such as camcorder, video playback, and video conferencing. Controller/processor 526 may direct the operation of various processing and interface units within digital section 520. Display processor 528 performs processing to facilitate the display of videos, graphics, and texts on a display unit 530.

ARM/DSP 532 may perform various types of processing for wireless device 500 and may implement pre-processing unit 330 in FIG. 3. ARM/DSP 532 may also execute GPU driver 320 in FIG. 3. Graphics processor 534 performs graphics processing and may implement post-processing unit 340 in FIG. 3. Internal memory 536 stores data and/or instructions for various units within digital section 520. EBI 538 facilitates transfer of data between digital section 520 (e.g., internal memory 536) and a main memory 540. Memories 536 and/or 540 may implement memory 350 in FIG. 3. Memory 530 may also implement a cache memory system having (1) configurable caches that may be assigned to different engines within graphics processor 534 and/or (2) dedicated caches that are assigned to specific engines.

Digital section 520 may be implemented with one or more DSPs, microprocessors, RISCs, etc. Digital section 520 may also be fabricated on one or more application specific integrated circuits (ASICs) or some other type of integrated circuits (ICs).

The techniques described herein may be implemented by various means. For example, these techniques may be implemented in hardware, firmware, software, or a combination thereof. For a hardware implementation, the processing units may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, etc.) that perform the functions described herein. The firmware and/or software codes may be stored in a memory (e.g., memory 536 and/or 540 in FIG. 5) and executed by a processor (e.g., processor 526 and/or 532). The memory may be implemented within the processor or external to the processor.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. An apparatus comprising:
a first processing unit operative to perform pre-processing on a batch of graphics application data for an image and generate a plurality of command sub-lists for the batch, each command sub-list including a portion of intermediate data generated for the batch; and
a second processing unit operative to perform post-processing on the plurality of command sub-lists and generate output data for the image, and wherein the first and second processing units are operable in parallel, the first processing unit operable to perform pre-processing for one of the plurality of command sub-lists and the second processing unit operable to concurrently perform post-processing for another one of the plurality of command sub-lists.

2. The apparatus of claim 1, wherein the first processing unit performs pre-processing for vertices in the image.

3. The apparatus of claim 1, wherein the second processing unit performs post-processing for pixels of the image.

4. The apparatus of claim 1, wherein each command sub-list includes data for complete primitives of the image.

5. The apparatus of claim 1, further comprising:
a memory operative to store the plurality of command sub-lists.

6. The apparatus of claim 5, wherein the memory stores the plurality of command sub-lists as a circular buffer.

7. The apparatus of claim 5, wherein the memory further stores a look-up table of memory addresses for the plurality of command sub-lists.

8. The apparatus of claim 5, wherein the memory further stores a header for each of the plurality of command sub-lists.

9. The apparatus of claim 8, wherein the header for each command sub-list indicates whether the command sub-list is a first command sub-list for the batch and a size of the command sub-list.

10. The apparatus of claim 5, wherein the memory further stores a write counter indicating a command sub-list most recently generated by the first processing unit.

11. The apparatus of claim 10, wherein the first processing unit generates the plurality of command sub-lists in a sequential order, and wherein the write counter is updated after generating each command sub-list.

12. The apparatus of claim 5, wherein the memory further stores a read counter indicating a command sub-list most recently post-processed by the second processing unit.

13. The apparatus of claim 12, wherein the second processing unit performs post-processing on the plurality of command sub-lists in a sequential order, and wherein the read counter is updated after post-processing each command sub-list.

14. The apparatus of claim 1, wherein the second processing unit stores a write counter indicating a command sub-list most recently generated by the first processing unit and a read counter indicating a command sub-list most recently post-processed by the second processing unit.

15. The apparatus of claim 1, further comprising:
a driver operative to convert high-level commands for the batch to low-level commands for the first processing unit.

16. The apparatus of claim 1, further comprising:
a driver operative to convert high-level commands for the batch and generate a plurality of command arrays for the batch, wherein the driver and the first processing unit are operable in parallel, the driver generating one of the plurality of command arrays and the first processing unit concurrently processing another one of the plurality of command arrays.

17. The apparatus of claim 16, further comprising:
a memory operative to store a write counter indicating a command array most recently generated by the driver and a read counter indicating a command array most recently processed by the first processing unit.

18. An integrated circuit comprising:
a first processing unit operative to perform pre-processing on a batch of graphics application data for an image and generate a plurality of command sub-lists for the batch, each command sub-list including a portion of intermediate data generated for the batch; and
a second processing unit operative to perform post-processing on the plurality of command sub-lists and generate output data for the image, and wherein the first and second processing units are operable in parallel, the first processing unit operable to perform pre-processing for one of the plurality of command sub-lists and the second processing unit operable to concurrently perform post-processing for another one of the plurality of command sub-lists.

19. The integrated circuit of claim 18, further comprising:
a memory operative to store the plurality of command sub-lists as a circular buffer.

20. The integrated circuit of claim 19, wherein the memory further stores a header for each of the plurality of command sub-lists, the header for each command sub-list indicating whether the command sub-list is a first command sub-list for the batch and a size of the command sub-list.

21. The integrated circuit of claim 19, wherein the memory unit further stores a write counter indicating a command sub-list most recently generated by the first processing unit and a read counter indicating a command sub-list most recently post-processed by the second processing unit.

22. A wireless device comprising:
a first processing unit operative to perform pre-processing on a batch of graphics application data for an image and generate a plurality of command sub-lists for the batch, each command sub-list including a portion of intermediate data generated for the batch; and
a second processing unit operative to perform post-processing on the plurality of command sub-lists and generate output data for the image, and wherein the first and second processing units are operable in parallel, the first processing unit operable to perform pre-processing for one of the plurality of command sub-lists and the second processing unit operable to concurrently perform post-processing for another one of the plurality of command sub-lists.

23. The wireless device of claim 22, further comprising:
a memory operative to store the plurality of command sub-lists as a circular buffer.

24. The wireless device of claim 23, wherein the memory further stores a header for each of the plurality of command sub-lists, the header for each command sub-list indicating whether the command sub-list is a first command sub-list for the batch and a size of the command sub-list.

25. The wireless device of claim 23, wherein the memory unit further stores a write counter indicating a command sub-list most recently generated by the first processing unit and a read counter indicating a command sub-list most recently post-processed by the second processing unit.

26. A method comprising:
performing pre-processing on a batch of graphics application data for an image and generating a plurality of command sub-lists for the batch, each command sub-list including a portion of intermediate data generated for the batch; and
performing post-processing on the plurality of command sub-lists and generating output data for the image, and
wherein the pre-processing and post-processing are performed in parallel, the pre-processing being performed for one of the plurality of command sub-lists and the post-processing being performed concurrently for another one of the plurality of command sub-lists.

27. The method of claim 26, further comprising:
storing the plurality of command sub-lists as a circular buffer.

28. The method of claim 26, further comprising:
storing a header for each of the plurality of command sub-lists, the header for each command sub-list indicating whether the command sub-list is a first command sub-list for the batch and a size of the command sub-list.

29. The method of claim 26, further comprising:
storing a write counter indicating a command sub-list most recently generated by the pre-processing; and
storing a read counter indicating a command sub-list most recently post-processed.

30. An apparatus comprising:
means for performing pre-processing on a batch of graphics application data for an image and generating a plurality of command sub-lists for the batch, each command sub-list including a portion of intermediate data generated for the batch; and
means for performing post-processing on the plurality of command sub-lists and generating output data for the image, and
wherein the means for performing pre-processing and the means for performing post-processing are operable in parallel, the means for performing pre-processing operating on one of the plurality of command sub-lists and the means for performing post-processing concurrently operating on another one of the plurality of command sub-lists.

31. The apparatus of claim 30, further comprising:
means for storing the plurality of command sub-lists as a circular buffer.

32. The apparatus of claim 30, further comprising:
means for storing a header for each of the plurality of command sub-lists, the header for each command sub-list indicating whether the command sub-list is a first command sub-list for the batch and a size of the command sub-list.

33. The apparatus of claim 30, further comprising:
means for storing a write counter indicating a command sub-list most recently generated by the pre-processing; and
means for storing a read counter indicating a command sub-list most recently post-processed.
